(19) United States
(12) Patent Application Publication
(10) Pub. No.: US 2021/0192129 A1
(43) Pub. Date: Jun. 24, 2021

(54) METHOD, SYSTEM AND CLOUD SERVER FOR AUTO FILING AN ELECTRONIC FORM

(71) Applicant: Varun Garg, Houston, TX (US)

(72) Inventor: Varun Garg, Houston, TX (US)

(21) Appl. No.: 17/191,773

(22) Filed: Mar. 4, 2021

Related U.S. Application Data
(60) Provisional application No. 63/054,895, filed on Jul. 22, 2020.

(51) Int. Cl. G06F 40/174; G06F 40/205

(52) U.S. Cl. CPC G06F 40/174; G06F 40/205

(57) ABSTRACT

The embodiments herein provide a method, system and a cloud server for auto filling an electronic form. The method comprises transmitting an image of a document to a cloud server, identifying a type and layout of the document from the image of the document, extracting one or more textual data from the image of the document based on the identification. The method further comprises comparing the extracted one or more textual data with pre-defined fields in the electronic form, and auto filling the extracted one or more textual data in the pre-defined fields based on the result of comparison.

### CROSS-REFERENCE TO RELATED APPLICATIONS

This application claims the benefit of U.S. Provisional Application No. 63/054,895, filed on 22 Jul. 2020. The entire disclosure of the above application is hereby incorporated herein by reference.

### TECHNICAL FIELD

The present invention relates generally to a method, system and a cloud server that facilitate completion of electronic forms, and more particularly, to a method, system and a cloud server for auto filling electronic forms from a document using machine learning techniques.

### BACKGROUND

Many business-related forms are available in electronic format. In some cases, the information for filling in these forms is present in a printed document. For example, an electronic form for inputting information relating to a book may include fields such as author, title, ISBN number, publisher, and dates. Forms also exist for inputting information from business cards, IDs, correspondence, and other physical documents so that the information is available in electronic format.

Traditionally, optical character recognition (OCR) techniques employ software which extracts textual information from scanned images. Such techniques have been applied to extract textual information from books, business cards, and the like. Once text is extracted, each text line can be tagged as to data type. The extracted information can be used to pre-fill corresponding fields in an electronic form. Other information may be inputted manually.

However, OCR techniques used for form population invariably result in some errors, both in the recognition of the individual characters in the digital document and in the correct association of the extracted information with specific fields of the form. Further, manual input of information is time consuming and also generally incurs errors.

Additionally, Google's Chrome Web browser is equipped with an autofill function to help users quickly type in form data. It is meant to be a time-saving feature, but it often becomes an obstruction when it fills in the wrong information. Or the right information in the wrong places. It seems that most of these conventional autofill extensions require a lot of typing, editing, and maintenance.

Although auto-fill systems are proposed in the past, they have their own shortcomings or limitations, thus there still exist a need for a more reliable solution. Accordingly, proposed is a method and system for auto filling an electronic form using artificial intelligence which results in less typing, editing, and maintenance.

### SUMMARY

It will be understood that this disclosure in not limited to the particular systems, and methodologies described, as there can be multiple possible embodiments of the present disclosure which are not expressly illustrated in the present disclosure. It is also to be understood that the terminology used in the description is for the purpose of describing the particular versions or embodiments only, and is not intended to limit the scope of the present disclosure.

In one non-limiting embodiment, a method for auto filling an electronic form is disclosed. The method comprises transmitting an image of a document to a cloud server, identifying a type and layout of the document from the image of the document, extracting one or more textual data from the image of the document based on the identification. The method further comprises comparing the extracted one or more textual data with pre-defined fields in the electronic form, and auto filling the extracted one or more textual data in the pre-defined fields based on the result of comparison.

In another non-limiting embodiment, a cloud server used for auto filing an electronic form is provided. The cloud server comprising a transceiver, a memory and a processor coupled to the transceiver and the memory. The processor is configured to receive an image of a document, identify a type and layout of the document from the image of the document, extract one or more textual data from the image of the document based on the identification. The processor is further configured to compare the extracted one or more textual data with pre-defined fields in the electronic form, and auto fill the extracted one or more textual data in one or more pre-defined fields based on the result of comparison.

In another non-limiting embodiment, a system for auto filing an electronic form is provided. The system comprising a computing device and a cloud server. The computing device is configured to capture an image of a document, transmit the captured image of the document to the cloud server. The cloud server is configured to identify a type and layout of the document from the image of the document, extract one or more textual data from the image of the document based on the identification, compare the extracted one or more textual data with pre-defined fields in the electronic form, auto fill the extracted one or more textual data in the pre-defined fields based on the result of comparison. The cloud server is further configured to display the auto filed textual data on the computing device.

These and other features and advantages of the present invention will become apparent from the detailed description below, in light of the accompanying drawings.

### BRIEF DESCRIPTION OF THE DRAWINGS

FIG. 1 illustrates a computing environment or general implementation for a computing device enabled by machine learning, according to an exemplary embodiment of the present invention;

FIG. 1A illustrates a block diagram of a cloud server, according to an exemplary embodiment of the present invention;

FIG. 2 illustrates a flow diagram of interaction between a user, an application on the computing device, and a Cloud server for auto filling an electronic form, according to an exemplary embodiment of the present invention;

FIG. 3 is a schematic illustration of the extraction of textual data from an exemplary physical document in the form of a business card, and the population of selected fields of the electronic form, according to an exemplary embodiment of the present invention;

FIG. 4A illustrates a screenshot of capturing an image of the physical document, according to an exemplary embodiment of the present invention;

FIG. 4B illustrates a screenshot of population of selected fields of the electronic form, according to an exemplary embodiment of the present invention;

FIG. 4C illustrates a screenshot of storing the electronic form, according to an exemplary embodiment of the present invention;

FIGS. 5A-5B illustrate screenshots of different types of documents, according to an exemplary embodiment of the present invention; and

FIG. 6 illustrates a flow diagram of a method for auto filling the electronic form, according to an exemplary embodiment of the present invention.

### DETAILED DESCRIPTION

As used in the specification, the singular forms “a”, “an” and “the” may also include plural references. For example, the term “an article” may include a plurality of articles. Those with ordinary skill in the art will appreciate that the elements in the figures are illustrated for simplicity and clarity and are not necessarily drawn to scale. There may be additional components or processes described in the foregoing application that are not depicted on the described drawings. In the event such a component or process is described, but not depicted in a drawing, the absence of such component and process from the drawings should not be considered as an omission of such design from the specification.

Before describing the present invention in detail, it should be observed that the present invention utilizes a combination of components or processes, which constitutes a system and method for use in analyzing an electronic document. Accordingly, the components or processes have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific component level details and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment. The words “comprising”, “having”, “containing”, and “including”, and other forms thereof, are intended to be equivalent in meaning and be open ended in that an item or items following any one of these words is not meant to be an exhaustive listing of such item or items or meant to be limited to only the listed item or items.

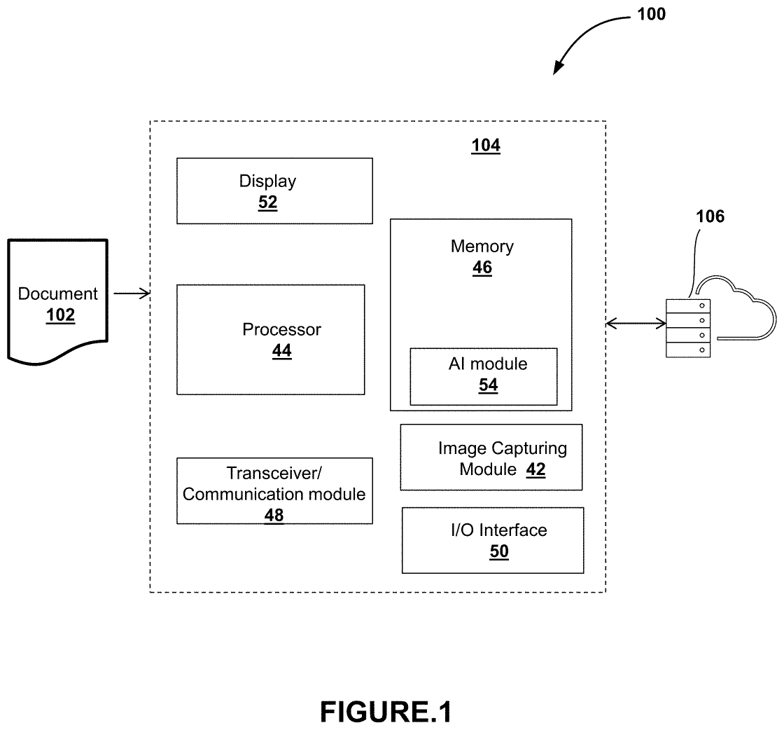

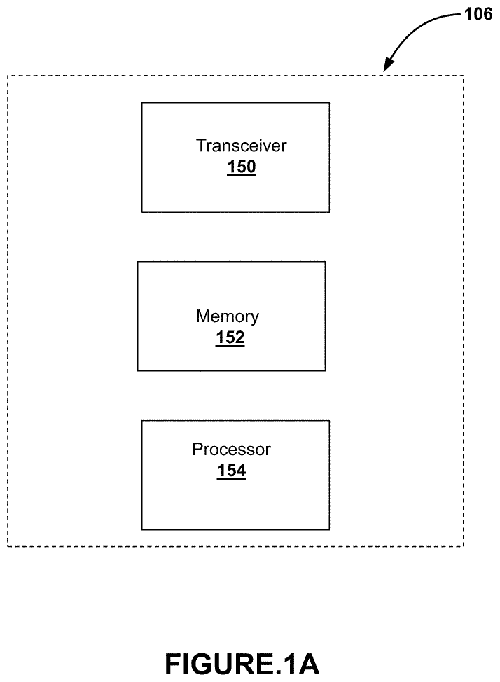

The system and method for auto filling an electronic form will now be described with reference to the accompanying drawings, particularly FIGS. 1-6.

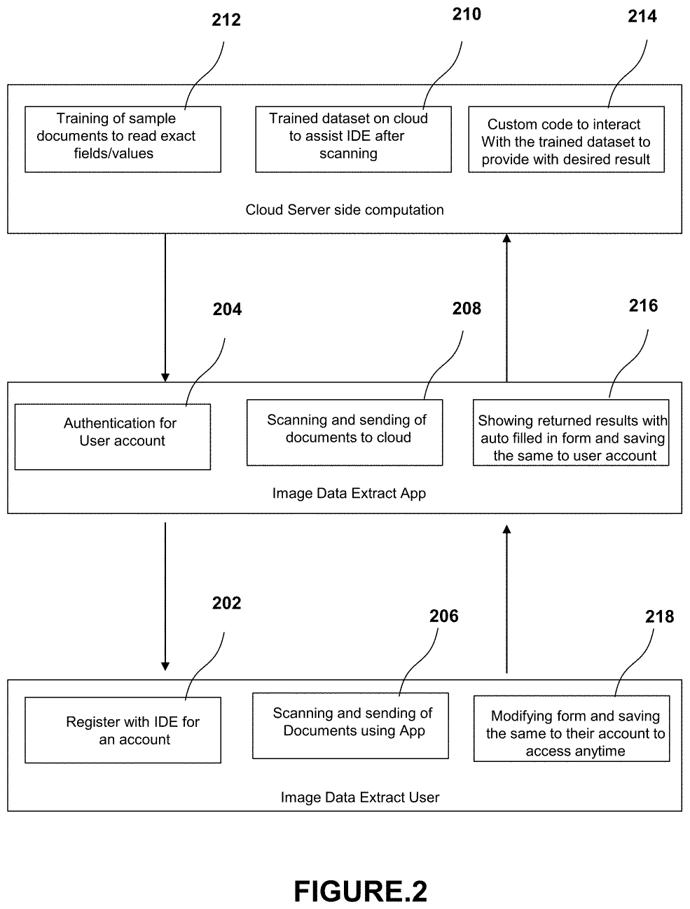

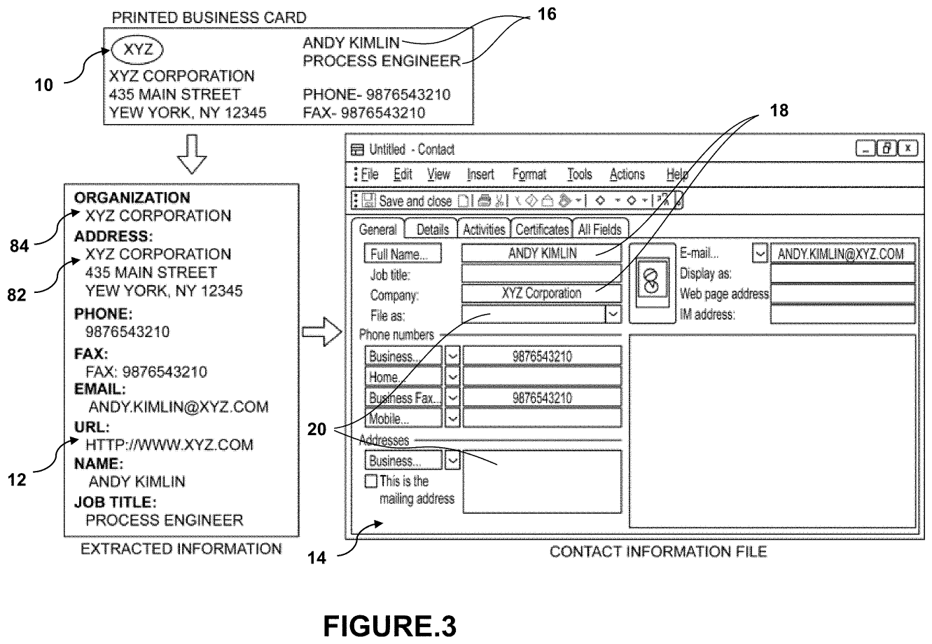

Referring to FIG. 1 in conjunction with FIGS. 2-3, a system 100 enabled by artificial intelligence for auto filling an electronic form is shown, in accordance with an exemplary embodiment of the present invention. The system 100 comprises a computing device 104 and a server 106. The computing device 102 scans/captures a document 102. Examples of the document 102 include, but are not limited to an electronic book (e-book), a Portable Document Format (PDF) file, invoices, receipts and business cards, handwritten document and the like. In an embodiment, the server 106 is a cloud server. In one embodiment, the cloud server may include a Google cloud sever. In another embodiment, the cloud server may include a Microsoft sever. In yet another embodiment, the cloud server may include amazon cloud-based server. In yet another embodiment, the cloud server may include cloud-based server from Microsoft offering services such as Azure Form recognizer. However, the cloud-based servers mentioned here are not limited to the one mentioned here and may include any cloud based server.

In context of the present invention, the computing device 104 refers to an electronic device that can be used to communicate over the communication network. Examples of the computing device 104 include, but are not limited to a cell phone, a smart phone, a cellular phone, a cellular mobile phone, a personal digital assistant (PDA), a personal computer, a server, a cloud enabled devices, a laptop, and a tablet computer. Examples of types of the communication network include, but are not limited to a local area network, a wide area network, a radio network, a virtual private network, an internet area network, a metropolitan area network, a satellite network, Wi-Fi, Bluetooth Low energy, a wireless network, and a telecommunication network. Examples of the telecommunication network include, but are not be limited to a global system for mobile communication (GSM) network, a general packet radio service (GPRS) network, third Generation Partnership Project (3GPP), 4G, Long-Term Evolution (LTE), an enhanced data GSM environment (EDGE) and a Universal Mobile Telecommunications System (UMTS).

In accordance with an example implementation, as shown in FIG. 1, the computing device 104 comprises an image capturing module 42, a processor 44 coupled to one or more memory, such as memory 46, and a transceiver or communication module 48. The computing device 104 may also include one or more I/O interfaces, such as an I/O interface 50, a display 52.

The processor 44 may be communicably coupled with the transceiver/communication module 48 to receive signals. Further, the transceiver 48 may be configured to transmit signals generated by the processor 44. The processor 44 is in communication with the memory 46 and may store routines, programs, objects, components, data structures and the like, which perform particular tasks to be executed by the processor 44. The computing device 104 may be connected to other information processing devices by using the I/O interface 50. The display 52 may be utilized to display the electronic form as shown in FIG.3. The I/O interfaces 50 may include a variety of software and hardware interfaces, for instance, interface for peripheral device(s) such as a keyboard, a mouse, a scanner, an external memory, a printer and the like.

In an embodiment, the processor 44 may include different types of processors known in the art including neural network-based algorithms that are effectively used in several applications. In an aspect of the present invention, processor or the neural network may process large amount of data in real-time.

In context of the present invention, a user (not shown) can upload or capture an image of the document 102 by the computing device 104. In an embodiment, uploading of the image of the document occurs from multiple sources that comprises API upload, email, SFTP, web portal (drag and drop) and mobile application. The computing device 104 receives the document 102 for analysis and auto filling the electronic form.

Referring to FIG. 1A now, the server 106 is shown. The server 106 comprises a transceiver 150, a memory 152 and a processor 154 coupled to the transceiver 150 and the memory 152. The server 106 is configured to receive the image of the document captured by the computing device 104.

After receiving the image, the processor 154 is configured to identify a type and layout of the document from the image of the document. The ways of identifying the type and layout of the document are explained below.

The server may be configured to apply one or more machine learning techniques to identify the type and layout of the document 102. For this, the server 106 comprises a machine learning model. The machine learning model may use one or more machine learning techniques to identify the type and layout of the document 102 from the image of the document. In one embodiment, the machine learning model may continuously learn over a period of time.

In one embodiment, the machine learning model takes as input a plurality of images of a plurality of documents. The plurality of images of the plurality of documents are used to train the machine learning model. Training of the machine learning model helps in identifying similar document when inputted next time. For example, if an image of a business card is received by a machine learning model, the machine learning model compares the received image of the business card with the previously trained images of all the documents. Upon comparing, the machine learning model identifies that the received image is an image of the business card.

Similarly, different documents may have different layouts. For example, in one document the “name” of a person may be written at the top while in another document the “name” of a person may be written at a bottom. Thus, the machine learning model trains itself for all such scenarios. Upon receiving an image, the machine learning model can easily identify the layout of the image based on the comparison of the received images with the previously trained images.

Once the type and layout of the document is completed, the processor 154 is configured to extract one or more textual data from the image of the document. The one or more textual data may include, in the case of a business card, name of a person, name of a company/firm, phone number of the company/firm, address of the company/firm.

In one embodiment, the extraction of the one or more textual data also involves the use of machine learning model. For example, considering a business card, name of the person may be different in different formats in different business cards. For example, some business card may have a format “name” while some may have “first name”. Similarly, some may have last name before the first name while the other may have first name before the last name. Thus, by comparing the extracted textual data with one or more textual data present in the trained images may help to accurately identify the data present in the image of the document.

The main objective of the present invention is to auto fill the textual data present in an image of a document in various data field present in an electronic form. The data field may include, but not limited to, name of a person, name and address of a company/firm, phone number of a company/firm.

Hence, once the one or more textual data is identified, the processor 154 is configured to compare the extracted one or more textual data with pre-defined fields in the electronic form. For example, the textual data “name” may be compared with all the data fields present in the electronic form. Once a match is found (i.e., data field “name” is found), the textual data i e , name of a person is automatically filled in the matched data field in the electronic form.

In an embodiment, the machine learning technique includes optical character recognition (OCR). In an embodiment, the machine learning model employs at least one hidden Markov model (HMM) to determine an appropriate field into which the extracted textual data can be entered.

In one embodiment, if there are any unfilled portion of the electronic form remains, the user gets the ability to choose and drop textual data in the appropriate place. For example, if the business card comprises a name of the product sold by the company/firm and there is no data field “product” in the electronic form, the user may manually enter the product from the business card in the corresponding data field electronic form by choosing and dropping the product from the business card (for example, from editable version of business card obtained after applying OCR techniques). By repetition of above process, the machine learning model may get itself trained in multiple machine learning models which helps with the refilling of the fields of the electronic form when a similar image is chosen. In an embodiment, the machine learning model self-learn new document designs and layouts without the need for new templates.

In an embodiment, the machine learning model employs colour to indicate that an extracted textual data is compatible with a particular field in the electronic form. In an embodiment, the machine learning model permits the user to verify at least one textual data in at least one field is correct.

FIG. 2 illustrates a flow diagram of interaction between a user, an application on the computing device 104, and a Cloud server 106 for auto filling the electronic form, according to an exemplary embodiment of the present invention. At step 202, the user registers with the application (referred to as IDE) on the computing device 104 for an account. In an embodiment, the user can use his/her existing email account or social network account to access the application.

The application provides different login/registration facility to the user according to their convenience so as how they want to keep their documents in which account. The application has different authentication mechanism which user can choose during registration. In user registration the user needs to fill in the details as required which allows the user to login using the same credentials. Once the user is registered then an email for verification is being sent to the user to verify that the user has authentic email ID. After verification email only then the user can access the account for scanning and keeping their documents safely in internet/mobile device.

At step 204, the application on the computing device 104 authenticates the user before account creation. In an embodiment, the application implements two factor authentication. At step 206, after creating an account, the user scans/captures the document and transmits it by using the application. In an embodiment, the user can use guest mode to scan/capture the document and transmit it by using the application. At step 208, the application transmits the images (i.e., scanned/captured documents) to the cloud server 106. At step 210, the cloud server 106 includes the AI module 54 that includes machine learning model. The machine learning model includes trained dataset (i.e., machine learning is used for training the dataset) to assist the application after scanning At step 212, the machine learning model identifies type and layout of the document and extracts one or more textual data based on the identification. At step 214, the machine learning model may include custom code to interact with the trained dataset to provide/return with appropriate results.

At step 216, the application displays results with auto filled textual data in the electronic form and saving them to user account after comparing the extracted one or more textual data with one or more data fields present in the electronic form. At step 218, the user modifies the electronic form (i.e., choose and drop textual data in the unfilled portion of the electronic form) and save them in his/her account.

FIG. 3 is a schematic illustration of the extraction of textual data from an exemplary physical document in the form of a business card 10, and the population of selected fields of the electronic form, according to an exemplary embodiment of the present invention. The electronic form is populated with at least some of the extracted information, while other fields are left blank for manual entry.

In the illustrated embodiment, the business card 10 is a physical card, such as a 5×8.5 cm business card or similar-sized business card that is commonly carried by business and professional persons. However, it is to be appreciated that the method is equally applicable to automated form filling with information from other printed documents, such as incoming mail, medical records, identification cards, such as drivers' licenses, book and technical article information, such as author, title, ISBN number, publisher, dates, and so forth. The personal information content of business cards typically includes personal name, job title, affiliation (such as a company name, university name, organization, or the like), business address information, business telephone number, business facsimile number, email address, and so forth, arranged in lines 16 of text, and may also include a graphical affiliation logo (such as a corporate logo, university logo, firm logo, and so forth). A given business card may include only some of these items or all of these items, and may include additional or other information.

As shown in FIG. 3, the exemplary form 14 includes a number of data fields 18, 20, etc. which are to be populated with information extracted from the business card. Exemplary fields for a form 14 to be populated with information from business cards such as business card 10 may include “person name,” “job title,” “company name,” “business phone number,” “home phone,” “business fax number,” and the like. The data fields of the form 14 may each be designated, during the course of the method, as an automatically populated field 18, to be automatically populated with information, or a manually populated field 20, to be manually populated by a user. The fields to be manually populated 20 may be highlighted in some way to distinguish them from the automatically populated fields 18. The automatically populated fields 18 are generally fields for which the user is able to modify the content, either by deleting the entire content and typing in the entire content of the field, or by correcting content of an automatically populated field, where appropriate. Other fields 20 designated manually populated are not populated, but are to be filled in by the user, and may be highlighted with a different color. The designation of the fields of a form as automatic/manual is based on a number of features. Some of the features are error-related features which take into account the likelihood for errors in populating the field.

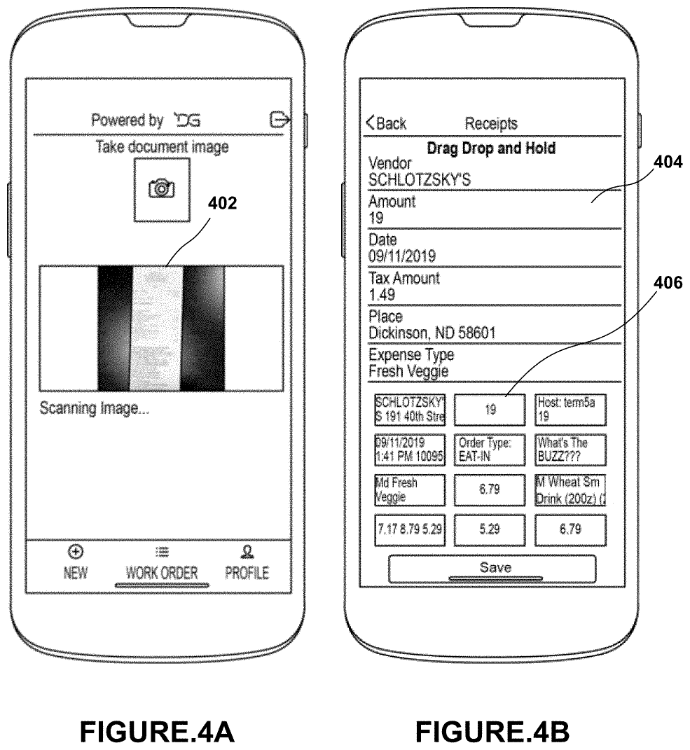

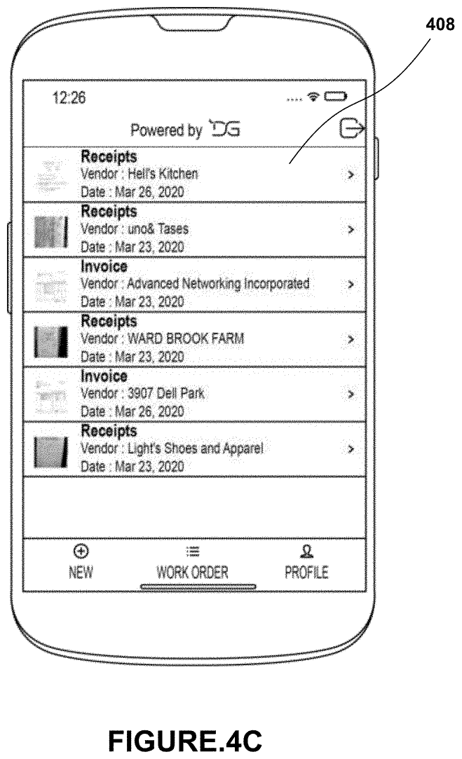

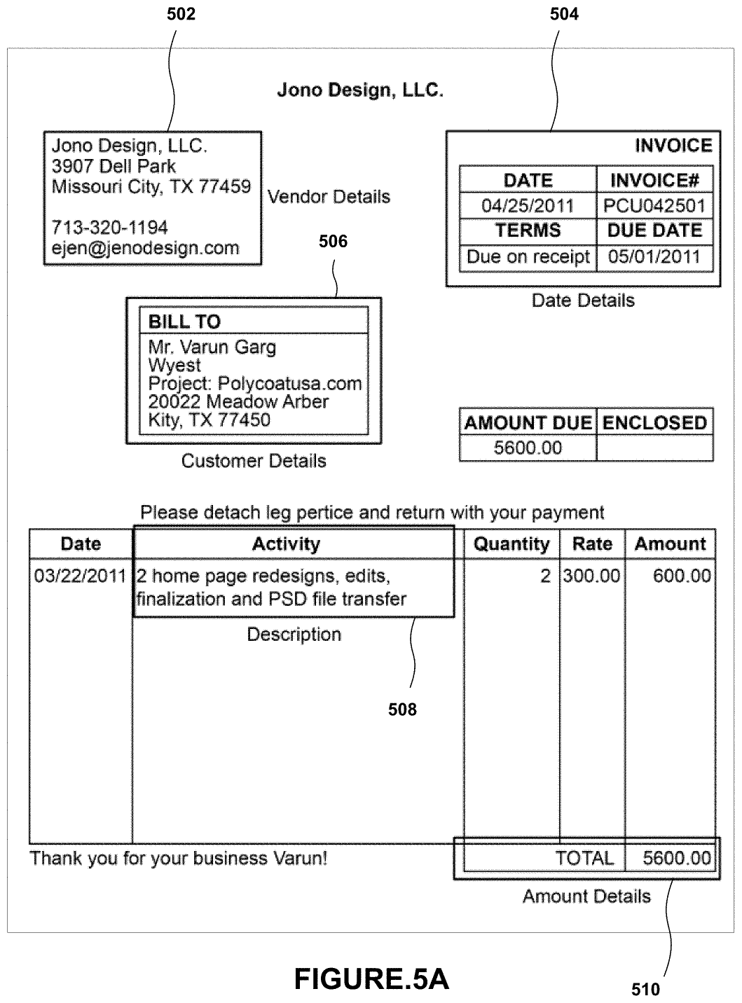

FIG. 4A illustrates a screenshot of capturing the image of the physical document 102, according to an exemplary embodiment of the present invention. As shown, the user can capture the image 402 of the physical document 102 by a camera module (i.e., Image capturing module 42) of the computing device 104.

FIG. 4B illustrates a screenshot of population of selected data fields of the electronic form, according to an exemplary embodiment of the present invention. As shown, the fields of the electronic form include an automatically populated field 404. If any field is not populated automatically, the user can choose and drop textual data 406 in the unfilled portion of the electronic form.

FIG. 4C illustrates a screenshot of storing the electronic form, according to an exemplary embodiment of the present invention. As shown, the auto filled form 408 is stored in the user account.

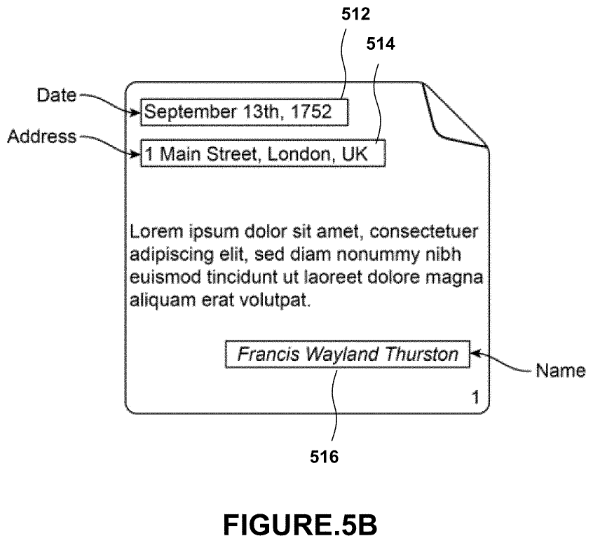

FIGS. 5A-5B illustrate screenshots of different types of documents, according to an exemplary embodiment of the present invention. As shown in FIG. 5A, the captured/uploaded image is an invoice. The invoice includes different fields such as vendor details 502, date detail 504, customer detail 506, activity description 508, and amount details 510. The user captures the invoice and the application on the computing device 104 scans the captured image and know it is an invoice and extract the details such as date, vendor, customer, amount, etc. Once Scanned and retrieved the data, the application shows those data to the user for further modification or saving the same in their mobile device/account.

As shown in FIG. 5A, the captured image is the business card. The machine learning techniques extracts rectangles of text which might correspond to a data field in electronic form. These rectangles are then fed through the machine learning model to determine if the text corresponds to a company name, the total sum of an invoice, or any of the other fields which the electronic form has. For example, the machine learning models uses random forest for rectangle classification. Random forest works by constructing several decision trees (hence the forest) during training time, and then using those decision trees for classification. Likewise, the other example for a document shown in FIG. 5B shows different data fields as date 512, address 514 and name 516. The user can scan the document and the data in respective fields is then extracted, the application then shows those data to the user for further modification or saving the same in their mobile device/account.

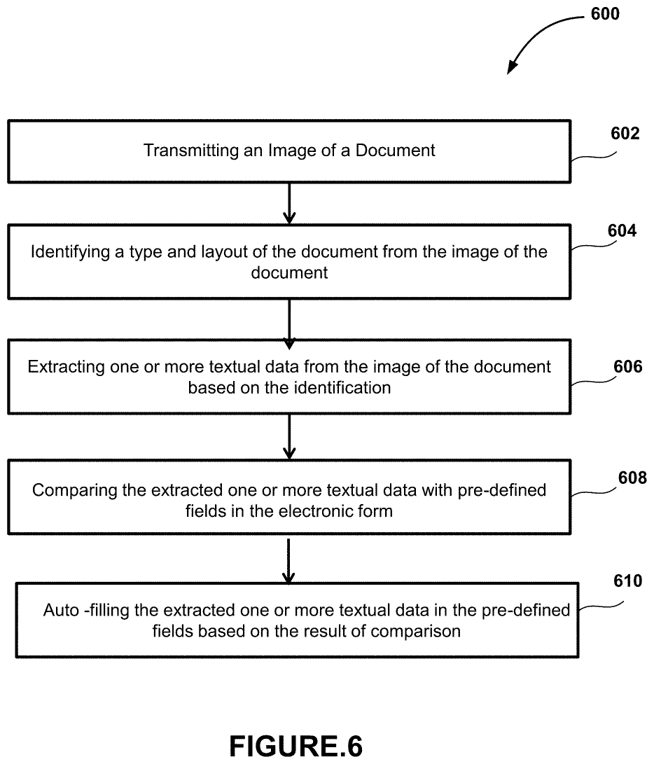

FIG. 6 illustrates a flow diagram of a method 600 for auto filling the electronic form, according to an exemplary embodiment of the present invention. At step 602, the method includes transmitting the image of the document 102. The image is transmitted to a cloud server 106 by a computing device 104. At step 604, the method comprises identifying a type and a layout of the document from the image of the document. The method allows the AI module 54 comprising machine learning model identifying type and layout of the document. The machine learning model applies one or more machine learning techniques. At step 606, the method comprises extracting one or more textual data from the image of the document based on the identification. The method allows machine learning model for extraction of the one or more textual data. At step 608, the method comprises comparing the extracted one or more textual data with pre-defined data fields in an electronic form. At step 610, the method comprises auto filling the electronic form based on the result of comparison.

The various actions, acts, blocks, steps, or the like in the flow diagram may be performed in the order presented, in a different order or simultaneously. Further, in some embodiments, some of the actions, acts, blocks, steps, or the like may be omitted, added, modified, skipped, or the like without departing from the scope of the invention.

Although particular embodiments of the invention have been described in detail for purposes of illustration, various modifications and enhancements may be made without departing from the spirit and scope of the invention.

What is claimed is:

1. A method for auto filling an electronic form, the method comprising:
transmitting an image of a document to a cloud server;
identifying a type and layout of the document from the image of the document;
extracting one or more textual data from the image of the document based on the identification;
comparing the extracted one or more textual data with pre-defined fields in the electronic form; and
auto filling the extracted one or more textual data in the pre-defined fields based on the result of comparison.

2. The method of claim 1, wherein the steps of identifying, extracting comprises:
using a machine learning model.

3. The method of claim 2, further comprising:
inputting a plurality of images of documents in the machine learning model;
training the inputted plurality of images of the documents.

4. The method of claim 3, wherein the step of identifying comprises comparing the transmitted image of the document with the trained plurality of images of the documents;
wherein the step of extracting comprises comparing the one of more textual data with one or more textual data present in the plurality of trained images of the documents.

5. The method of claim 1, wherein the type of document comprises electronic book (e-book), a Portable Document Format (PDF) file, invoices, receipts and business cards, handwritten document

6. The method of claim 1, wherein the machine learning model comprises hidden Markov model (HMM).

7. The method of claim 1, wherein the machine learning model uses optical character recognition techniques.

8. A cloud server used for auto filing an electronic form, the cloud server comprising:
a transceiver;
a memory;
a processor coupled to the transceiver and the memory and configured to:
receive an image of a document;
identify a type and layout of the document from the image of the document;
extract one or more textual data from the image of the document based on the identification;
compare the extracted one or more textual data with pre-defined fields in the electronic form; and
auto fill the extracted one or more textual data in one or more pre-defined fields based on the result of comparison.

9. The cloud server of claim 8, further comprising a machine learning model; wherein the identification, extraction is done using a machine learning model.

10. The cloud server of claim 9, wherein the processor is further configured to:
input a plurality of images of documents in the machine learning model;
train the inputted plurality of images of the documents.

11. The cloud server of claim 10, wherein the processor is configured to:
identify by comparing the transmitted image of the document with the trained plurality of images of the documents;
extract by comparing the one of more textual data with one or more textual data present in the plurality of trained images of the documents.

12. The cloud server of claim 8, wherein the type of document comprises electronic book (e-book), a Portable Document Format (PDF) file, invoices, receipts and business cards, handwritten document.

13. The cloud server of claim 8, wherein the machine learning model comprises hidden Markov model (HMM)

14. The cloud server of claim 8, wherein the machine learning model uses optical character recognition techniques.

15. A system for auto filing an electronic form, the system comprising:
a computing device;
a cloud server;
wherein the computing device is configured to:
capture an image of a document;
transmit the captured image of the document to the cloud server;
wherein the cloud server is configured to:
identify a type and layout of the document from the image of the document;
extract one or more textual data from the image of the document based on the identification;
compare the extracted one or more textual data with pre-defined fields in the electronic form;
auto fill the extracted one or more textual data in the pre-defined fields based on the result of comparison; and
display the auto filed textual data on the computing device.

16. The cloud server of claim 15, further comprising a machine learning model; wherein the identification, extraction is done using a machine learning model.

17. The cloud server of claim 16, wherein the cloud server is further configured to:
input a plurality of images of documents in the machine learning model;
train the inputted plurality of images of the documents.

18. The cloud server of claim 15, wherein the cloud server is configured to:
identify by comparing the transmitted image of the document with the trained plurality of images of the documents;
extract by comparing the one of more textual data with one or more textual data present in the plurality of trained images of the documents.

19. The cloud server of claim 15, wherein the type of document comprises electronic book (e-book), a Portable Document Format (PDF) file, invoices, receipts and business cards, handwritten document.

20. The cloud server of claim 15, wherein the machine learning model comprises hidden Markov model (HMM)
